(19) United States
(12) Patent Application Publication
(10) Pub. No.: US 2022/0233393 A1
(43) Pub. Date: Jul. 28, 2022

(54) MASSAGER

(71) Applicant: Christopher McKenna, Redondo Beach, CA (US)

(72) Inventor: Christopher McKenna, Redondo Beach, CA (US)

(21) Appl. No.: 17/582,770

(22) Filed: Jan. 24, 2022

Related U.S. Application Data
(60) Provisional application No. 63/140,285, filed on Jan. 22, 2021.

(51) Int. Cl. A61H 15/00

(52) U.S. Cl. CPC A61H 15/0085; A61H 2201/0188; A61H 2015/005; A61H 2015/0071; A61H 2015/0064

(57) ABSTRACT

Provided is a massager having a body, a massage attachment and at least two triggers for operation. The massage attachment may be removeably coupled to the massager and easily changed. The first trigger may allow a user to operate the massager in a first orientation and the second trigger may allow a user to operate the massager in a second orientation. A gripping surface may allow the user to effectively grip the massager in either the first or the second orientation while also allowing the user to operate one of the first or second triggers.

### RELATED APPLICATIONS

This application claims the benefit of U.S. Provisional Application No. 63/140,285 filed Jan. 22, 2021, which is hereby incorporated herein by reference.

### FIELD OF INVENTION

The present invention relates generally to a handheld massage device.

### BACKGROUND

Massages are often used to relieve stress and muscle tension. Handheld massage devices provide a consistent massaging motion (e.g., vibration) such that a patient's muscles are massaged by the motion or vibration of the device. Often handheld massage devices are powered by electricity and offer various intensity/power settings. Handheld massagers may be used by experienced masseuses or by untrained individuals.

### SUMMARY OF INVENTION

The present application relates to methods for improving a handheld massaging device. Massagers may be heavy and may be difficult for a user to hold while operating. In some instances, the user of the device may become sore or tired from holding the device during prolonged use. It is desirable to provide a massager that is functional and ergonomically pleasing to both the user and the patient.

In an exemplary embodiment, a handheld massaging device includes a body having first and second ends and a gripping surface, a first trigger proximate the first end, a second trigger proximate the second end, a motor disposed in the body, a battery disposed in the body, and a massage attachment having a shaft removably attached to the body at the second end.

According to an aspect, the body has a longitudinal axis, wherein the gripping surface extends along the longitudinal axis, and wherein the shaft has a longitudinal axis parallel to or coaxial with the longitudinal axis.

According to an aspect, the gripping surface can be grasped by a user in a first orientation with the massage attachment pointing in a first direction where the user's index finger activates the first trigger, and a second orientation with the massage attachment pointing in a second direction opposite the first direction where the user's index finger activates the second trigger.

According to an aspect, the gripping surface includes first, second, and third grip locations between the first and second triggers, wherein in the first orientation the user's fingers rest on the first trigger and the first, second and third grip locations, and wherein in the second orientation the user's fingers rest on the second trigger and the third, second, and first grip locations.

According to an aspect, each of the first and second triggers includes a safety.

According to an aspect, the handheld massaging device further includes a lock for each trigger to lock the respective trigger in an on position.

In an exemplary embodiment, a handheld massaging device includes a body having first and second ends and a gripping surface extending along a side of the body along a longitudinal axis of the body, a first trigger extending from the gripping surface proximate the first end, a second trigger extending from the gripping surface proximate the second end, a motor disposed in the body, and a massage attachment removably attached to the body at the second end and configured to be driven by the motor.

According to an aspect, the massaging device further includes a battery disposed in the body, wherein a battery charge indicator is provided for indicating a level of charge of the battery.

According to an aspect, the massaging device further includes a light array on the body extending along the longitudinal axis.

According to an aspect, the massage attachment includes a shaft removably attached to the body, the shaft extending in a direction along the longitudinal axis.

According to an aspect, the massage attachment includes a release lock biased in a first position to prevent removal of the massage attachment and movable to a second position to allow removal of the massage attachment.

According to an aspect, the gripping surface includes a plurality of curved grip locations for a user's fingers.

According to an aspect, the gripping surface can be grasped by a user in a first orientation with the massage attachment pointing in a first direction where the user's index finger activates the first trigger, and a second orientation with the massage attachment pointing in a second direction opposite the first direction where the user's index finger activates the second trigger.

According to an aspect, the gripping surface includes first, second, and third grip locations between the first and second triggers, wherein in the first orientation the user's fingers rest on the first trigger and the first, second and third grip locations, and wherein in the second orientation the user's fingers rest on the second trigger and the third, second, and first grip locations.

According to an aspect, each of the first and second triggers includes a safety that is engagable to prevent unintentional activation of the respective switch.

According to an aspect, the handheld massaging device further includes a lock for each trigger to lock the respective trigger in an on position.

In an exemplary embodiment, a handheld massaging device includes a body having first and second ends and a gripping surface extending along a side of the body along a longitudinal axis of the body, the gripping surface including a plurality of curved grip locations for a user's fingers, a first trigger extending from the gripping surface proximate the first end, a second trigger extending from the gripping surface proximate the second end, a motor disposed in the body, and a massage attachment having a shaft removably attached to the body at the second end and configured to be driven by the motor, the shaft extending along the longitudinal axis to be parallel to or coaxial with the longitudinal axis.

According to an aspect, each of the first and second triggers includes a safety that is engagable to prevent unintentional activation of the respective switch.

According to an aspect, the gripping surface can be grasped by a user in a first orientation with the massage attachment pointing in a first direction where the user's index finger activates the first trigger, and a second orientation with the massage attachment pointing in a second direction opposite the first direction where the user's index finger activates the second trigger.

According to an aspect, the gripping surface includes first, second, and third grip locations between the first and second triggers, wherein in the first orientation the user's fingers rest on the first trigger and the first, second and third grip locations, and wherein in the second orientation the user's fingers rest on the second trigger and the third, second, and first grip locations.

The foregoing and other features of the invention are hereinafter described in greater detail with reference to the accompanying drawings.

### BRIEF DESCRIPTION OF THE DRAWINGS

FIG. 1 is a front view of an exemplary embodiment of a massager.

FIG. 2 is a bottom view of an exemplary embodiment of a massaging attachment for a massager.

FIG. 3 is a side view of an exemplary embodiment of a massaging attachment for a massager.

FIG. 4 is a side view of another exemplary embodiment of a massaging attachment for a massager.

### DETAILED DESCRIPTION

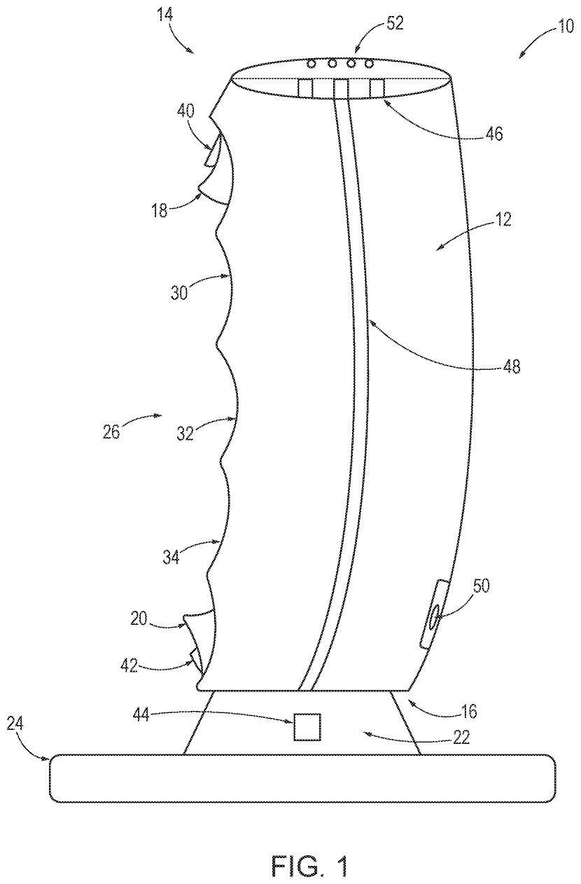

Turning now to FIG. 1, an exemplary embodiment of a massager is shown generally at reference numeral 10. The massager 10 may include a body 12 having a first end 14 and a second end 16, a first trigger 18, a second trigger 20, an attachment shaft 22, a massaging attachment 24, and at least one surface for gripping 26. The first end 14 may be opposite the second end 16. The first trigger 18 may be located proximate the first end 14, and the second trigger 20 may be located proximate the second end 16. The attachment shaft 22 may be located proximate the second end 16 such that a longitudinal axis of the attachment shaft 22 is coaxial with a longitudinal axis of the body 12. The attachment shaft 22 may allow a user to attach a massaging attachment 24 to the massager 10. The surface for gripping 26 may extend along a side wall of the body 12 from the first end 14 to the second end 16 to allow a user's hand to grasp the massager 10.

The massager 10 may further include interior components such as a motor and a battery source. The battery may power the motor, and the motor may create a massaging motion (e.g., rotation, vibration, translation, etc.) at the attachment shaft 22. The massaging motion at the attachment shaft 22 may translate to the massaging attachment 24 (e.g., when the massaging attachment 24 is attached to the massager 10). The massaging attachment 24 may then be applied to a patient's muscle, thereby applying the massaging motion to the muscle, for example. A user may control the operation of the massaging motion (e.g., turn the motor “ON” or “OFF”, etc.) using the first trigger 18 or the second trigger 20.

In an example, the surface for gripping 26 may be located on the same side of the body 12 as the first trigger 18 and the second trigger 20. In this example, the surface for gripping 26 may extend along a side wall of the body 12 from the first trigger 18 to the second trigger 20. This may allow a user to both grasp the massager 10 and simultaneously pull at least one of the first trigger 18 or the second trigger 20. Users will appreciate that the massager 10 may be operated using one of the two triggers 18, 20 without having to release the grasp of the surface for gripping 26. In this manner, the massager 10 may be operated using only one hand.

In an example, the locations of the first trigger 18, the second trigger 20, and the surface for gripping 26, may allow a user to grasp the massager 10 in at least two different orientations. In a first orientation, a user may grasp the massager 10 such that the user's index finger rests on the first trigger 18, the middle finger on location 30, the ring finger on location 32, and the pinky finger on location 34. In the first orientation, the massage attachment 24 may be pointed down towards the patient.

In a second orientation, a user may grasp the massager 10 such that the user's index finger rests on the second trigger 20, the middle finger on location 34, the ring finger on location 32, and the pinky finger on location 30. In the second orientation, the massage attachment 24 may be pointed up towards the patient. It should be appreciated that the user may choose to direct the massager 10 in any desired direction to massage a patient, and may also choose between holding the massager 10 in the first orientation or the second orientation.

The locations 30, 32, 34 can be configured to match a corresponding shape of a user's finger. For instance, the locations 30, 32, 34 can be curved to fit and engage the user's fingers during operation of the massager 10. It should also be appreciated that locations of the first trigger 18 and the second trigger 20 can also be configured with a curved grip location that can fit and engage the user's fingers (e.g., the index finger). Similarly, the first trigger 18 and the second trigger 20 can also be configured with a curvature to fit and engage a shape of a user's finger.

While holding the massager 10 in the first orientation, the user may operate the massager 10 (e.g., turn “ON” or “OFF”) by pulling the first trigger 18 (e.g., while the user's index finger is resting on the first trigger). While holding the massager 10 in the second orientation, the user may operate the massager 10 using the second trigger 20. It should be appreciated that either of the first trigger 18 or the second trigger 20 may operate the massager 10. In example, the massager 10 may be operated when either of the first trigger 18 and the second trigger 20 are pulled. In another example, only one trigger may operate the massager 10 at a given time.

The massager 10 may further include a first safety 40 for the first trigger 18 and a second safety 42 for the second trigger 20. The first and second safety 40, 42 may be located proximate the respective trigger (e.g., the first safety 40 proximate the first trigger 18 and the second safety 42 proximate the second trigger 20). When engaged, the first and second safety 40, 42 may prevent a user from pulling the respective trigger (e.g., prevent a user from accidently or unintentionally turning the device “ON”). When disengaged, the user may operate the disengaged trigger (e.g., may turn the device “ON”).

In an example, a user may hold the massager 10 in the first orientation with the first safety 40 disengaged and the second safety 42 engaged. This may allow a user to operate the massager 10 with the first trigger 18, while the second trigger 20 is disabled (e.g., using the second safety 42). In another example, the user may hold the massager 10 in the second orientation with the first safety 40 engaged and the second safety 42 disengaged to allow the user to operate the massager 10 with the second trigger 20. In another example, both the first safety 40 and the second safety 42 may be engaged to prevent the massager from accidently turning “ON” (e.g., during storage or nonuse). In an embodiment, operation of the massager 10 with one of the triggers 18 or 20 will activate the safety or an internal safety to prevent use of the other trigger.

The massager 10 may further include a first slide lock and a second slide lock located proximate the first and the second trigger 18, 20, respectively. The first and second slide lock may lock the first or the second trigger 18, 20 into an “ON” position when the lock is engaged. For example, a user operating the massager 10 in the first orientation may engage the first trigger 18 to turn the massager “ON”. To keep the first trigger 18 engaged, the user may engage the first slide lock to place the massager 10 in an “ALWAYS ON” mode. In other words, while the first slide lock is engaged, the first trigger 18 may stay engaged, and the massager may stay “ON”, without the user having to hold the first trigger 18. Second slide lock may operate in the same manner with respect to second trigger 20.

The attachment shaft 22 may allow a user to attach various massaging attachments 24 to the massager 10 to provide a massaging motion (vibration, circular movements, etc.). The massager 10 may further include a release lock 44 to facilitate removal and attachment of the massaging attachment 24 to massager 10. The release lock 44 may be pressed by the user to remove the massaging attachment 24 from the massager 10 (e.g., when pressed the massaging attachment 24 is disengaged/removed from the massager 10).

In an embodiment, the attachment shaft 22 is fixed to the massaging attachment 24 and removably coupled to the second end 16 of the massager 10 (e.g., using the release lock 44). In another embodiment, the attachment shaft 22 may be fixed to the second end of the massager 10 and removeably coupled to the massaging attachment 24. In yet another embodiment, the attachment shaft 22 may be removeably coupled to both the massager 10 and the massaging attachment 24.

The massager 10 may further include a speed selector switch 46. The speed selector switch 46 may allow a user to select a massaging speed of the massager 10. For example, the speed selector switch 46 may be a three position switch. The first position may be for a low speed, the second position for a medium speed, and the third position for a high speed. Low speed may be 1000 rotations per minute (rpm), medium may be 2000 rpm, and high may be 3500 rpm, for example. In another embodiment, the speed may be adjusted using a dial (e.g., potentiometer) allowing for any number of speed selections to be made. In yet another embodiment, the speed may be selected using pushing buttons. It should be appreciated, that the speed adjustment may be accomplished in any suitable manner according to sound engineering judgment. It should be also appreciated the massager 10 (e.g., the motor) may be configured to rotate at any suitable speed, and the values provided herein are for example only.

The massager 10 may also include a light array 48 on the body 12 of the massager 10. The light array 48 may indicate that the massager 10 is “ON”, for example. The light array 48 may be solid colors, multicolored, or a combination thereof. The light array 48 may change colors or displays while the massager 10 operating at different speeds. For example, when the massager 10 is operating at a low speed, the light array 48 may be solid green. The light array 48 may then be blue for medium, and orange for high. In another example, the light array 48 may flash or change colors during operation. It should be appreciated that the color of the light array 48 may be configured to account for any suitable need (e.g., indication, aesthetics, etc.).

The massager 10 may include a charge port 50 to allow a user to charge the battery of the massager 10. The battery may be a battery of any of the following technologies: lithium ion, lithium polymer, nickel cadmium, nickel-metal hydride, lead acid, or any other suitable composition. The charge port 50 may provide a connection port for a battery charger, for example. The charger may output 24 VDC or 25.2 VDC at 0.6 A, for example. It should be appreciated that the charge port 50 may be configured to accept any suitable charger at any suitable charge rate or voltage need.

Additionally, the massager 10 may include a battery charge indicator 52. The charge indicator 52 may be LED lights, for example. The battery charge indicator 52 may indicate when the power source (e.g., battery) of the massager 10 is fully charged or in need of a charge. It may indicate the status or charge level of the battery (e.g., charged or dead), may indicate the exact battery voltage (e.g., 22V, 24V, 25.2V, etc.), or may indicate battery percentage (e.g., 50%, 75%, 100%, etc.). The charge indicator 52 may also indicate when the battery is currently being charged and when the charge is complete. It should be appreciated that the charge indicator 52 may be configured according to sound engineering judgment to provide a useful indicator to the user to determine the status of the battery and/or charge process.

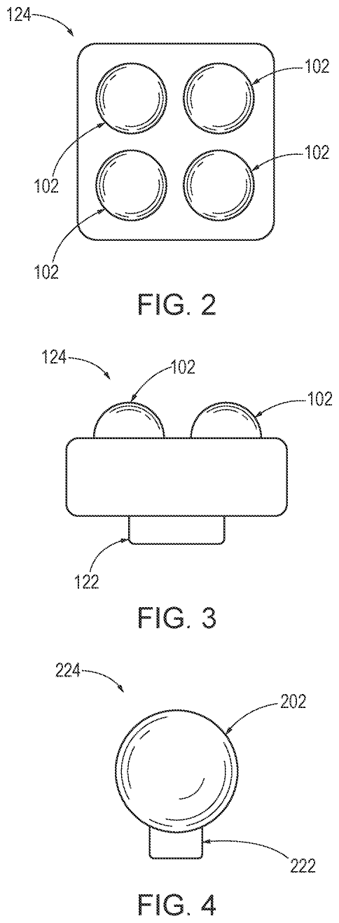

Turning to FIGS. 2 and 3, an exemplary embodiment of a massaging attachment is shown generally at reference numeral 124. Massaging attachment 124 may include one or more massaging balls 102 and an attachment shaft 122. The attachment shaft 122 may allow a user to removably couple the massaging attachment 124 to the massager 10 (e.g., at the second end 16). The massaging balls 102 may roll freely within the massaging attachment 124 or may be secured fully (e.g., no rotation).

Turning to FIG. 4, another exemplary embodiment of a massaging attachment is shown generally at reference numeral 224. Massaging attachment 224 may include a single massage ball 202 and an attachment shaft 222. The attachment shaft 222 may allow a user to removably couple the massaging attachment 224 to the massager 10. The massaging ball 202 may roll freely within the massaging attachment 224 or may be secured fully (e.g., no rotation).

It should be appreciated that the massaging attachments 24, 124, 224, may be configured according to a specific patient's massage needs. For example, any number of massage balls may be included with a massage attachment. The balls may rotate freely or be fully secured to the attachment. Further, suitable massage attachments having no massage balls may be used. The massager 10 may allow a user to easily swap out (e.g., change) massage attachments using the release lock 44.

Although certain embodiments have been shown and described, it is understood that equivalents and modifications falling within the scope of the appended claims will occur to others who are skilled in the art upon the reading and understanding of this specification.

What is claimed is:

1. A handheld massaging device including:
a body having first and second ends and a gripping surface;
a first trigger proximate the first end;
a second trigger proximate the second end;
a motor disposed in the body;
a battery disposed in the body; and
a massage attachment having a shaft removably attached to the body at the second end.

2. The handheld massaging device according to claim 1, wherein the body has a longitudinal axis, wherein the gripping surface extends along the longitudinal axis, and wherein the shaft has a longitudinal axis parallel to or coaxial with the longitudinal axis.

3. The handheld massaging device according to claim 1, wherein the gripping surface can be grasped by a user in a first orientation with the massage attachment pointing in a first direction where the user's index finger activates the first trigger, and a second orientation with the massage attachment pointing in a second direction opposite the first direction where the user's index finger activates the second trigger.

4. The handheld massaging device according to claim 3, wherein the gripping surface includes first, second, and third grip locations between the first and second triggers, wherein in the first orientation the user's fingers rest on the first trigger and the first, second and third grip locations, and wherein in the second orientation the user's fingers rest on the second trigger and the third, second, and first grip locations.

5. The handheld massaging device according to claim 1, wherein each of the first and second triggers includes a safety.

6. The handheld massaging device according to claim 1, further including a lock for each trigger to lock the respective trigger in an on position.

7. A handheld massaging device including:
a body having first and second ends and a gripping surface extending along a side of the body along a longitudinal axis of the body;
a first trigger extending from the gripping surface proximate the first end;
a second trigger extending from the gripping surface proximate the second end;
a motor disposed in the body; and
a massage attachment removably attached to the body at the second end and configured to be driven by the motor.

8. The handheld massaging device according to claim 7, further including a battery disposed in the body, wherein a battery charge indicator is provided for indicating a level of charge of the battery.

9. The handheld massaging device according to claim 7, further including a light array on the body extending along the longitudinal axis.

10. The handheld massaging device according to claim 7, wherein the massage attachment includes a shaft removably attached to the body, the shaft extending in a direction along the longitudinal axis.

11. The handheld massaging device according to claim 7, wherein the massage attachment includes a release lock biased in a first position to prevent removal of the massage attachment and movable to a second position to allow removal of the massage attachment.

12. The handheld massaging device according to claim 7, wherein the gripping surface includes a plurality of curved grip locations for a user's fingers.

13. The handheld massaging device according to claim 7, wherein the gripping surface can be grasped by a user in a first orientation with the massage attachment pointing in a first direction where the user's index finger activates the first trigger, and a second orientation with the massage attachment pointing in a second direction opposite the first direction where the user's index finger activates the second trigger.

14. The handheld massaging device according to claim 13, wherein the gripping surface includes first, second, and third grip locations between the first and second triggers, wherein in the first orientation the user's fingers rest on the first trigger and the first, second and third grip locations, and wherein in the second orientation the user's fingers rest on the second trigger and the third, second, and first grip locations.

15. The handheld massaging device according to claim 7, wherein each of the first and second triggers includes a safety that is engagable to prevent unintentional activation of the respective switch.

16. The handheld massaging device according to claim 7, further including a lock for each trigger to lock the respective trigger in an on position.

17. A handheld massaging device including:
a body having first and second ends and a gripping surface extending along a side of the body along a longitudinal axis of the body, the gripping surface including a plurality of curved grip locations for a user's fingers;
a first trigger extending from the gripping surface proximate the first end;
a second trigger extending from the gripping surface proximate the second end;
a motor disposed in the body; and
a massage attachment having a shaft removably attached to the body at the second end and configured to be driven by the motor, the shaft extending along the longitudinal axis to be parallel to or coaxial with the longitudinal axis.

18. The handheld massaging device according to claim 17, wherein each of the first and second triggers includes a safety that is engagable to prevent unintentional activation of the respective switch.

19. The handheld massaging device according to claim 17, wherein the gripping surface can be grasped by a user in a first orientation with the massage attachment pointing in a first direction where the user's index finger activates the first trigger, and a second orientation with the massage attachment pointing in a second direction opposite the first direction where the user's index finger activates the second trigger.

20. The handheld massaging device according to claim 17, wherein the gripping surface includes first, second, and third grip locations between the first and second triggers, wherein in the first orientation the user's fingers rest on the first trigger and the first, second and third grip locations, and wherein in the second orientation the user's fingers rest on the second trigger and the third, second, and first grip locations.
